(19) United States
(12) Patent Application Publication
(10) Pub. No.: US 2006/0090464 A1
(43) Pub. Date: May 4, 2006

(54) Powered variable volume gas lift assembly and a method of operating the same

(76) Inventor: John S. Kargilis, Northville, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/975,922

(22) Filed: Oct. 28, 2004

(51) Int. Cl. F15B 7/08

(52) U.S. Cl. 60/588

(57) ABSTRACT

A powered lift assembly and a method of providing a powered lift. The assembly includes a housing including a gas positioned within a chamber. A first piston is slidably positioned within the housing. A second piston includes a shaft. The second piston is slidably positioned within the housing. A motor is operably attached to the first piston. The motor is positioned substantially within the housing. The motor biases the first piston thereby displacing the gas. The displaced gas biases the second piston and shaft. The method includes providing a housing. A first piston force is generated substantially within the housing. A gas pressure is modulated as a result of the first piston force. A second piston force is generated as a result of the modulated gas pressure.

### TECHNICAL FIELD OF THE INVENTION

The present invention relates generally to gas springs. More particularly, the invention relates to a powered variable volume gas lift assembly.

### BACKGROUND OF THE INVENTION

The automotive industry is customer focused and, therefore, technology is always changing to meet consumer demands. In recent years, consumers have begun to require features that provide ease of entrance and access to a motor vehicle. To meet these demands, manufacturers have designed remote power open features to side doors and liftgates that add significantly to the utility and value of the vehicle. Initial designs for power liftgates were large and difficult to package within a vehicle. First generation power liftgate mechanisms included a prop rod attached to a chain driven bracket which was powered by a small motor. Further developments have led to hydraulic systems where hydraulic fluid forces the opening and closing of a particular gate. Most current power liftgate systems are packaged in the headliner or on one of the d-pillars. Packaging in such areas increases overall build complexity and prevents easy after market installation of a power liftgate system.

Gas springs are used in numerous applications within a vehicle including liftgates, trunks, hoods, etc. Gas springs are similar to mechanical springs, such as coils, in that they are compressible energy storing devices. Unlike mechanical springs, gas springs require an initial force to begin compression. After a full initial force is applied, the gas spring will begin to compress. Another difference relates to packaging size. Given a certain spring rate, a gas spring may be designed with half the packaging size of a mechanical spring. Yet another difference relates to the fact that gas springs have the ability to provide a controlled rate of extension (i.e., a controlled release of stored energy at a prescribed velocity).

Although gas springs provide numerous advantages, they are not inherently capable of fully opening and/or closing a liftgate, trunk, hood, and the like on their own. Typically, an outside force is required to assist the gas spring. As such, it would be desirable to provide a gas spring capable of inherently providing a powered lift. In many instances, providing a powered lift may require hardware that would serve to increase the overall packaging size of the gas spring.

### SUMMARY OF THE INVENTION

One aspect of the present invention provides a powered lift assembly. The assembly includes a housing including a gas positioned within a chamber. A first piston is slidably positioned within the housing. A second piston includes a shaft. The second piston is slidably positioned within the housing. A motor is operably attached to the first piston. The motor is positioned substantially within the housing. The motor biases the first piston thereby displacing the gas. The displaced gas biases the second piston and shaft.

Another aspect of the invention provides a method of providing a powered lift. The method includes providing a housing. A first piston force is generated substantially within the housing. A gas pressure is modulated as a result of the first piston force. A second piston force is generated as a result of the modulated gas pressure.

Another aspect of the invention provides a powered lift assembly. The assembly includes housing means. Means are provided for generating a first piston force substantially within the housing means, and for modulating a gas pressure as a result of the first piston force. Means are further provided for generating a second piston force as a result of the modulated gas pressure, and for compensating for temperature variation.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is a schematic view of a powered lift assembly in accordance with one embodiment of the present invention;

FIG. 2 is a perspective view of the assembly shown in FIG. 1 showing the positioning of the assembly with respect to a vehicle; and

FIG. 3 is a detailed view of a second piston positioned within a housing in accordance with one embodiment of the present invention.

### DETAILED DESCRIPTION OF THE PRESENTLY PREFERRED EMBODIMENTS

Referring to the drawings, wherein like reference numerals refer to like elements,

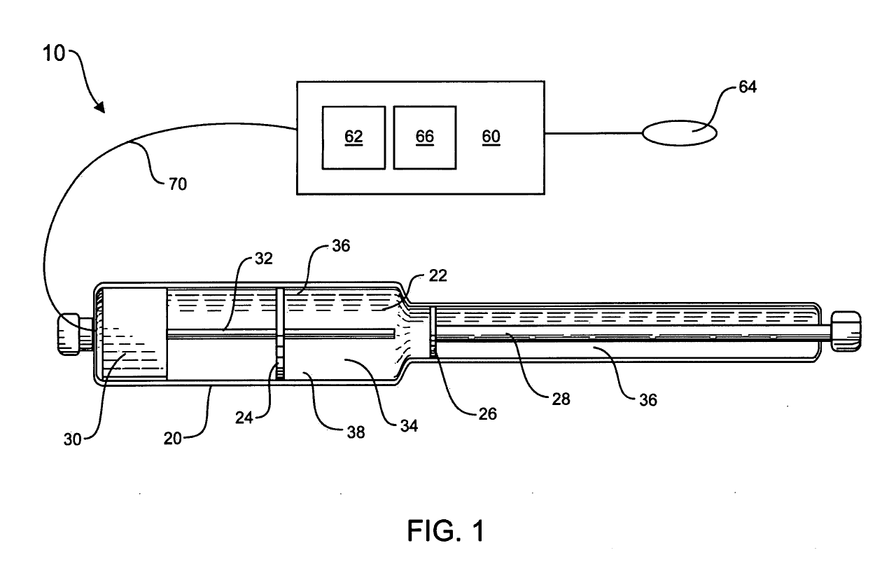

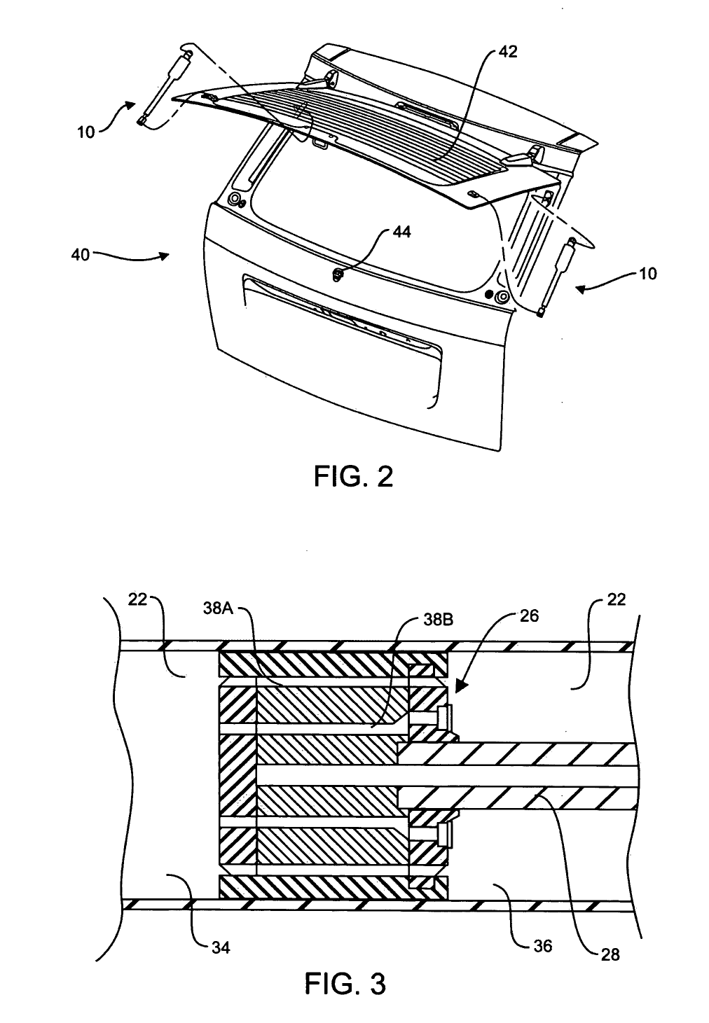

FIG. 1 is a schematic view of a powered lift assembly, shown generally by numeral 10, in accordance with one embodiment of the present invention. Assembly 10 includes a housing 20 with a gas positioned within a chamber 22. A first piston 24 is slidably positioned within the housing 20. A second piston 26 includes a shaft 28. Second piston 26 is slidably positioned within the housing 20. A motor 30 is operably attached to the first piston 24. Motor 30 is positioned substantially within the housing 20. Referring also to FIG. 2, the assembly 10 is shown with respect to a liftgate 42 of a vehicle 40. Those skilled in the art will recognize that the assembly 10 and vehicle 40 may include a number of alternative designs and may be employed in a variety of applications. For example, the assembly 10 may be used to open and/or close doors, trunks, hoods, and the like. In addition, the assembly 10 is not limited to use in vehicles. The Inventors contemplate numerous other uses and applications of the assembly 10.

In one embodiment, as shown in FIG. 1, the housing 20 may be in a stepped configuration wherein the diameter of the housing 20 is larger surrounding the first piston 24 and motor 30. The stepped configuration provides additional volume for housing the motor 30 as well as it provides a sufficient change in overall volume, as described further below. Gas chamber 22 is positioned within an inner portion 34 (i.e., the space between the first piston 24 and the second piston 26) and an outer portion 36 (i.e., the space to the right of the second piston 26) of the housing 20. Gas in chamber 22 may be an inert gas, such as nitrogen, which will not react with the components of the assembly 10. First piston 24 is operably attached to the motor 30 with a motor shaft 32. A seal may be provided between the first piston 24 and an inner surface of the housing 20. First piston 24 seal ensures that the gas remains confined within the inner and outer portions 34, 36. A lubricant 38 may be positioned within the housing 20 to reduce friction and wear of the assembly 10. Lubricant 38 may be one or more oil, grease, fluid, and the like known in art.

In one embodiment, the motor 30 may be a stepper-type motor. Stepper-type motors may be viewed as electric motors without commutators. All of the commutation must be handled externally by the motor controller, and typically the motors and controllers are designed so that the motor may be held in any fixed position as well as being rotated one way or the other. Most stepper-type motors can be stepped at audio frequencies, allowing them to spin quite quickly, and with an appropriate controller they may be quickly started and stopped at controlled orientations. In another embodiment, the motor 30 may be another type of motor or powered device for displacing the first piston 24.

Assembly 10 may include a controller 60 operably attached to the motor 30 via a wire harness assembly 70. Controller 60 includes a digital microprocessor 62. Controller 60 may be programmed to process a plurality of input signals received from various sensors, switches, a remote control, etc. A temperature sensor 64 may provide ambient temperature readings. Controller 60 may be a part of a vehicle computer commonly found in many vehicles. The computer usable medium including a program for operating the assembly 10 and for temperature compensation, and the program code associated with the presently preferred embodiments may be read into and stored in a memory portion 66 (e.g., ROM, RAM, EPROM, EEPROM, and the like) for access by the microprocessor 62, as understood in the art. Furthermore, value tables, variables, parameters, data, and other information may be stored as required in the memory portion 66. Analog signal processing may be provided for some of the input signals received by the controller 60. For example, the information sent from the sensors and remote control may be low-pass filtered through analog filter(s) to reduce signal noise.

In one embodiment, as shown in FIG. 3, the second piston 26 may include at least one, in this case two, bypasses 38a, 38b. Bypasses 38a, 38b permit the gas in chamber 22 to move through the second piston 26. As such, the pressure of the gas in chamber 22 may be substantially in equilibrium between both sides of the second piston 26. Those skilled in the art will appreciate that numerous bypasses and restrictor type check valves known in the art may be adapted for use with the present invention. Different applications of the assembly 10 may require different bypasses and/or check valves.

During operation of the assembly 10, which is described in the context of opening and then closing of the liftgate 42, self-rise begins by triggering a cinch latch 44 thereby unlocking the liftgate 42. Cinch latch 44 may be unlocked manually or automatically by, for example, triggering a remote control or a switch.

A first piston 24 force is generated substantially within the housing 20. Specifically, power is supplied to the motor 30 via the wire harness assembly 70. The operation of the motor 30 is under the control of the controller 60. The activated motor 30 rotates the motor shaft 32. Motor shaft 32 may include threads that correspond to threads within the first piston 24. As such, the rotation in the motor shaft 32 results in a linear displacement of the first piston 24 toward the second piston 26. The displacement of the first piston 24 provides the first piston 24 force.

Gas pressure in chamber 22 is modulated as a result of the first piston 24 force. As the first piston 24 moves closer to the second piston 26, the volume of the inner portion 34 decreases. The displaced gas results in an increase in pressure.

A second piston 26 force is generated as a result of the modulated gas pressure in chamber 22. The increased gas pressure provides a force that biases the second piston 26 and shaft 28 away from the first piston 24. As a result, the shaft 28 moves out of the housing 20. As the shaft 28 moves outward, it provides a force for opening the liftgate 42.

Closing the liftgate 42 begins by activating the motor 30 in a reverse direction thereby moving the first piston 24 toward the motor 30. As the first piston 24 moves, the volume of the inner portion 34 increases and the gas pressure in chamber 22 likewise decreases. The load of the liftgate 42 forces the shaft 28 and second piston 26 to move toward the first piston 24 thereby allowing the liftgate 42 to slowly close. When the liftgate 42 nears the closed position, the cinch latch 44 grabs on and locks thereby securing the close.

It is understood that temperature may have an affect on the assembly 10, particularly by changing the pressure of the gas in chamber 22. To compensate, the controller 60 may, in one embodiment, determine ambient temperature via the temperature sensor 64. Look up tables, equations, and the like may be programmed into the memory portion 66 of the controller 60 for determining a desired operation of the assembly 10 at various temperatures. Those skilled in the art understand the calibration of gas springs and like devices at various temperatures. In another embodiment, a temperature compensation module may be adapted for use with the present invention.

While the embodiments of the invention disclosed herein are presently considered to be preferred, various changes and modifications can be made without departing from the spirit and scope of the invention. For example, the power lift assembly configuration, and method of providing a powered lift are not limited to any particular design or sequence. Specifically, the housing, gas, first and second pistons, shaft, motor, and method thereof may vary without limiting the utility of the invention.

Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

1. A powered lift assembly comprising:
a housing including a gas positioned within a chamber;
a first piston slidably positioned within the housing;
a second piston including a shaft, the second piston slidably positioned within the housing; and
a motor operably attached to the first piston, the motor positioned substantially within the housing; wherein the motor biases the first piston thereby displacing the gas; wherein the displaced gas biases the second piston and shaft.

2. The assembly of claim 1 further comprising a wire harness assembly operably attached to the motor.

3. The assembly of claim 1 further comprising a controller operably attached to the motor.

4. The assembly of claim 3 wherein the controller comprises a computer usable medium including a program for operating the powered lift assembly, the computer usable medium comprising:
computer readable program code for operating the motor; and
computer readable program code for temperature compensation.

5. The assembly of claim 1 wherein the first piston comprises a seal with the housing.

6. The assembly of claim 1 wherein the second piston comprises at least one gas bypass.

7. The assembly of claim 1 wherein the motor comprises a stepper-type motor.

8. The assembly of claim 1 wherein the housing comprises a stepped configuration.

9. The assembly of claim 1 wherein the gas is in equilibrium between both sides of the second piston.

10. The assembly of claim 1 wherein the powered lift assembly is operably attached to a vehicle.

11. The assembly of claim 10 wherein the powered lift assembly is operably attached to a liftgate of the vehicle.

12. The assembly of claim 1 wherein the first piston is operably attached to the motor with a motor shaft.

13. The assembly of claim 12 wherein the motor rotates the motor shaft.

14. A method of providing a powered lift, the method comprising:
providing a housing;
generating a first piston force substantially within the housing;
modulate a gas pressure as a result of the first piston force; and
generating a second piston force as a result of the modulated gas pressure.

15. The method of claim 14 wherein generating the first piston force comprises displacing a first piston.

16. The method of claim 14 further comprising equalizing a gas pressure.

17. The method of claim 14 further comprising compensating for temperature variation.

18. The method of claim 14 wherein modulating the gas pressure comprises varying volume of a portion of the housing.

19. The method of claim 14 further comprising controlling generation of the first piston force.

20. A powered lift assembly comprising:
housing means;
means generating a first piston force substantially within the housing means;
means for modulating a gas pressure as a result of the first piston force; and
means for generating a second piston force as a result of the modulated gas pressure; and
means for compensating for temperature variation.
